(19) United States
(12) Patent Application Publication
(10) Pub. No.: US 2012/0117497 A1
(43) Pub. Date: May 10, 2012

(54) METHOD AND APPARATUS FOR APPLYING CHANGES TO A USER INTERFACE

(75) Inventors: Juha Tapani Uola, Tampere (FI); Antero Taivalsaari, Siivikkala (FI); Jaakko Tuosa, Helsinki (FI); Olli Antero Rantapuska, Vantaa (FI); Johan Rainersson Wikman, Helsinki (FI)

(73) Assignee: Nokia Corporation, Espoo (FI)

(21) Appl. No.: 12/941,604

(22) Filed: Nov. 8, 2010

(51) Int. Cl. G06F 3/048

(52) U.S. Cl. 715/762

(57) ABSTRACT

An approach is provided for applying changes to a user interface. The window manager receives an input for specifying at least one change to one or more components of a first user interface. Next, the window manager determines respective execution states of one or more applications associated with the user interface. Then, the window manager determines to apply the at least one change to generate a second user interface while preserving the respective execution states.

### BACKGROUND

Service providers and device manufacturers (e.g., wireless, cellular, etc.) are continually challenged to deliver value and convenience to consumers by, for example, providing compelling features. One area of interest has been improving features of user interfaces of a user device (e.g., a cell phone or other mobile devices, computer, etc). A portion of the user interface is generally managed by a window manager. The window manager is system software that manages various aspects of the windows in the user interface, and may often communicate with hardware devices such as a keyboard and a mouse to affect the user interface as well as the windows within the user interface. Further, software features to modify the appearance of the user interface, such as theming software, have been developed to enable users to change the appearance of the windows, icons and backgrounds in the user interface, as well as sound and other features related to the user interface. However, the currently available window managers may require a cumbersome process when making modifications to the features of the user interface. For example, in order to modify some features of the user interface, the system many need to be shut down and restarted, for the modifications to take effect. Accordingly, device manufacturers face significant technical challenges in providing an approach that can modify the user interface without having much effect in other software applications.

### SOME EXAMPLE EMBODIMENTS

Therefore, there is a need for an approach for applying changes to a user interface.

According to one embodiment, a method comprises receiving an input for specifying at least one change to one or more components of a first user interface. The method also comprises determining to preserve respective execution states of one or more applications associated with the first user interface. The method further comprises determining to apply the at least one change to generate a second user interface for presenting the one or more applications based, at least in part, on the preserved respective execution states.

According to another embodiment, an apparatus comprises at least one processor, and at least one memory including computer program code, the at least one memory and the computer program code configured to, with the at least one processor, cause, at least in part, the apparatus to receive an input for specifying at least one change to one or more components of a first user interface. The apparatus is also caused to determine to preserve respective execution states of one or more applications associated with the first user interface. The apparatus is further caused to determine to apply the at least one change to generate a second user interface for presenting the one or more applications based, at least in part, on the preserved respective execution states.

According to another embodiment, a computer-readable storage medium carries one or more sequences of one or more instructions which, when executed by one or more processors, cause, at least in part, an apparatus to receive an input for specifying at least one change to one or more components of a first user interface. The apparatus is also caused to determine to preserve respective execution states of one or more applications associated with the first user interface. The apparatus is further caused to determine to apply the at least one change to generate a second user interface for presenting the one or more applications based, at least in part, on the preserved respective execution states.

According to another embodiment, an apparatus comprises means for receiving an input for specifying at least one change to one or more components of a first user interface. The apparatus also comprises means for determining to preserve respective execution states of one or more applications associated with the first user interface. The apparatus further comprises means for determining to apply the at least one change to generate a second user interface for presenting the one or more applications based, at least in part, on the preserved respective execution states.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings:

FIG. 1 is a diagram of a system capable of applying changes to a user interface, according to one embodiment;

FIG. 2 is a diagram of the components of the user interface manager, according to one embodiment;

FIG. 3 is a flowchart of a process for applying changes to a user interface, according to one embodiment;

FIG. 4 is a flowchart of a process 400 for utilizing the status information of the user interface, according to one embodiment;

FIG. 5 is a flowchart of a process 500 for applying an update to the user interface, according to one embodiment;

FIG. 6 is a diagram showing components of the UE and the server, and interactions thereof, according to one embodiment of the invention;

FIGS. 7A-7B are diagrams of user interfaces utilized in the processes of FIG. 3, according to various embodiments;

FIGS. 8A-8D are examples of user interfaces that can be used as an interface for the UE 101, according to various embodiments.

FIG. 9 is a diagram of hardware that can be used to implement an embodiment of the invention;

FIG. 10 is a diagram of a chip set that can be used to implement an embodiment of the invention; and

FIG. 11 is a diagram of a mobile terminal (e.g., handset) that can be used to implement an embodiment of the invention.

### DESCRIPTION OF SOME EMBODIMENTS

Examples of a method, apparatus, and computer program for applying changes to a user interface are disclosed. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

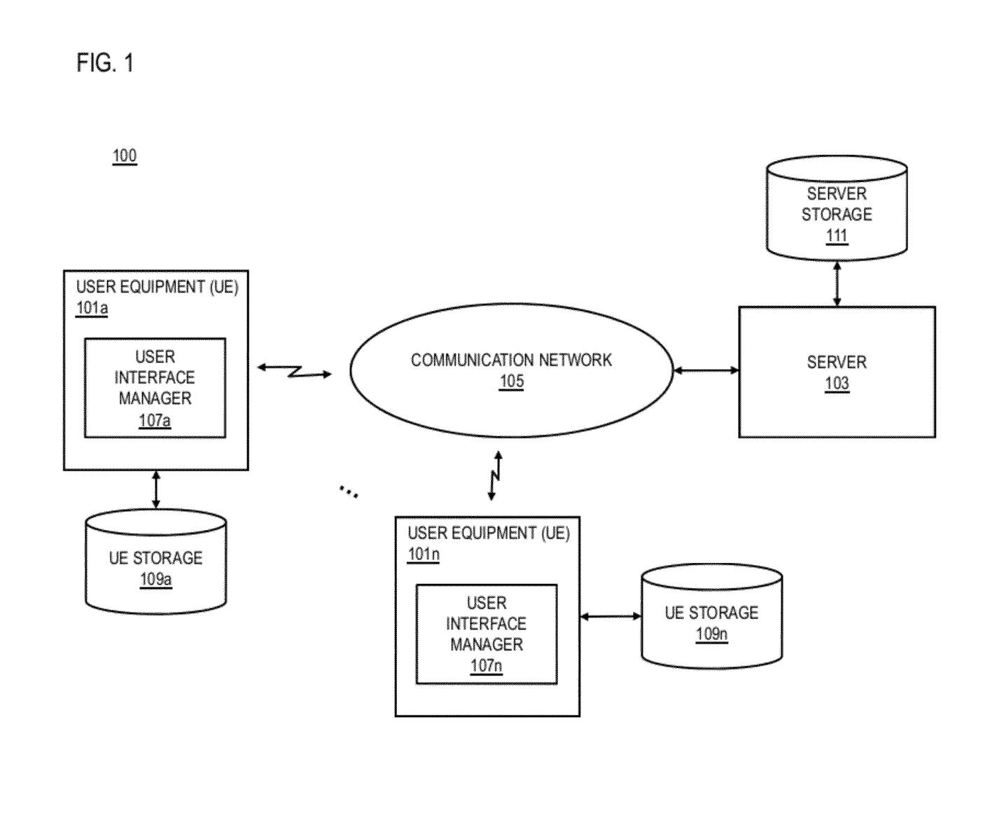

FIG. 1 is a diagram of a system capable of applying changes to a user interface, according to one embodiment. As discussed previously, applying changes to the user interface may involve undesirable processes including shutting down the system and rebooting. These processes may be complicated and may take a long time to finish applying changes to the user interface. Further, if the changes to the user interface involve more than aesthetic changes (e.g., changes in color, background etc.) to the user interface, it is likely that the system may need to go through extensive changes in software, which may require rebooting of the system or other processes that involve deeper level changes in the software components. Then, the user will experience the burden of having to wait for the system to finish the process of making changes. Especially when there are applications running in the device, the conventional approach to make changes to the user interface may force exiting from the application before making changes to the user interface, risking loss of status of the applications or work performed using the applications. In addition, changes to a main user interface for a user device such as a top-level user interface cannot generally be performed in a centralized manner. Conventionally, updating a top-level user interface requires software installation followed by a rebooting of the device to finish the installation. Therefore, the conventional approach may distract the user from using the device because the user interface needs time-consuming processes to finish changes to the user interface.

To address this problem, a system 100 of FIG. 1 introduces the capability to apply changes to a user interface are disclosed. The system 100 receives an input for specifying a change to one or more components of a first user interface. The first user interface may be a currently-existing user interface before changes are applied. The components may be software components within the user interface, and these components may be functional components that are responsible for executing certain functions. For example, the components may specify one or more characteristics for opening, closing, minimizing, maximizing, moving, resizing, navigating, or a combination thereof one or more outputs of software applications running in the user interface. The components may also be aesthetic components used for appearances of the user interface. Once the system 100 receives the input specifying the change, the system 100 determines to preserve respective execution states of one or more applications associated with the first user interface. The applications associated with the user interface may be software applications running on the device and having some interaction with the user interface. For example, the software applications may be actively running on respective windows displayed on the user interface, and this state of the application may be preserved. Then, the system 100 applies the change to generate a second user interface for presenting the one or more applications based, at least in part, on the preserved respective execution states. The second user interface incorporates the changes applied by the system 100. The execution states are preserved such that the application states and/or any other information associated with the application are the same as or similar to the states and/or information before the change is applied to generate the second user interface.

In one sample use case, a manufacturer of a user equipment may have updates available for the users having a user interface Y in the user equipment, wherein the updates change version 1 of the user interface Y to version 2. Then, the manufacturer places a user interface version 2 user interface (UI) declaration to a server, which may be maintained by the manufacturer. The server checks which clients (user equipments) have the user interface Y version 1, and transmits the user interface Y version 2 declaration to the clients having the user interface Y version 1. Each UI declaration has a unique identifier for a source of a corresponding user interface, such as a link to download the user interface, etc. Thus, if a user equipment selects the UI declaration, the UI declaration directs the user equipment to a source of the corresponding user interface such that the user equipment can retrieve the user interface.

When the user equipment receives the user interface Y version 2 declaration, the user interface Y version 2 declaration is cached at the user equipment. If there is a user interface Y version 1 currently active in the top-level user interface, and there is a request to change it to the user interface Y version 2, then the user equipment saves the status of the top-level user interface. Then, the user equipment stops the user interface Y version 1, makes the requested changes to generate the user interface Y version 2, and starts the user interface Y version 2 based on the cached user interface version 2 declaration and the stored states of the top-level user interface while preserving the states of the running applications. This enables changing the currently running user interface Y version 1 to the user interface Y version 2, while having the applications remain running in the same way as before the changes occurred.

As shown in FIG. 1, the system 100 comprises a user equipment (UE) 101 having connectivity to the server 103 via a communication network 105. The UE 101 has a user interface manager 107, which is used to maintain and control the user interface of the UE 101. Thus, the user interface manager 107 also makes changes to the user interface, and maintains the status of the user interface and preserves the states of the running applications when the changes are made. The UE 101 is also connected to the UE storage medium 109 that can be used to store various types of data, and can also be used as a cache-type storage. For example, information related to the status of the user interface may be stored in the UE storage 109 during the process to make changes to the user interface. Also, user interface declarations may be cached in the UE storage 109, wherein different user interface declarations may be selected to retrieve and run corresponding user interface at the UE 101. Additionally, the server 103 may also be a source of the user interfaces declarations or an updates to user interfaces that the UE 101 already has. The server 103 may be connected to the server storage medium 111. The server storage medium 111 may be used to store data for various user interfaces and/or updates to the user interfaces. The server storage medium 111 may also store information about users, their user equipments and the types and versions of the user interfaces that are in the user equipments.

In one embodiment, the system 100 initiates a transition between the first user interface and the second user interface based on predetermined criteria, user input, or a combination thereof. For example, the user may specify via the user input whether the transition is to be performed from the first user interface to the second user interface after the second user interface is generated. Further, when predetermined criteria are satisfied, the transition is to be performed from the first user interface to the second user interface. As one example, the transition may be initiated when the system determines that there is an updated version of the first user interface.

When the change is applied to generate the second user interface, the system 100 may determine status information associated with the first user interface, and restore at least a portion of the second user interface following application of the change based on the status information. The status information may include one or more identifiers of the one or more applications, location and dimensional information of displays associated with the one or more applications, and status information of the windows. For example, if the first user interface has a window showing a list of media files and a window with a document reader for an essay, then the status information about these windows in this first user interface may be determined, and may be used to restore the window showing the list of the media files and the window with the document reader for the essay when the second user interface is started. This enables maintaining the same status of the user interface and the running applications while the changes are made to generate the second user interface, such that when the second user interface is started, the running applications and the windows of the user interface stay the same or similar to the state before the changes.

In one embodiment, the system 100 may maintain the first user interface and the second user interface concurrently. In this embodiment, because both the first user interface and the second user interface are available, swapping between the first user interface and the second user interface may take place quickly. In addition, according to this embodiment, if the first user interface and information associated with the first user interface and applications running in the first user interface still exist after generating the second user interface, then the status information of the first user interface does not need to be stored in the UE storage 109. Otherwise, if the first user interface and the second user interface are not maintained concurrently, then the status information may be lost as the first user interface is stopped to start the second user interface, and thus may need to be stored to maintain the status for the second user interface. In a preferred embodiment, the time period of the first user interface and the second user interface being maintained concurrently may be a limited time period. The length of this time period may be limited by a processing power and a capacity of the UE 101.

Further, in one embodiment, the system 100 may generate a notification to at least one of the one or more applications in response to the input for specifying the at least one change to the first user interface. This notification may alert the at least one application to initiate an operation to modify the application based on the at least one change to the first user interface. For example, when a status of the first user interface is changed, the notification may be sent to the application such that the application may adapt to the change, if necessary.

The system 100 may also place restrictions in the UI declarations. For example, the UE 101 may allow only the UI declarations that direct to the sources that are approved by the manufacturer of the UE 101. The purpose of the restrictions is to have a security feature that protects from downloading a user interface that may be malicious to the UE 101. Further, the communication between the UE 101 and the server 103 may utilize a secure protocol (e.g. HTTPS) that allows identifying the server from which the UI declaration is received.

Therefore, an advantage of this approach is that by applying changes to the first user interface to generate the second user interface while preserving states of the first user interface and applications running on the first user interface, the changes to the user interfaces can be applied without interruption. For example, a transition between user interfaces may be made while preserving execution states of applications as well as status information associated with the first user interface. Because this approach is capable of preserving various types of information including status of the functional components of the user interface as well as application's execution states and the data, more complex changes can be made to the user interface while minimizing interruption. Therefore, means for applying changes to a user interface is anticipated.

By way of example, the communication network 105 of system 100 includes one or more networks such as a data network (not shown), a wireless network (not shown), a telephony network (not shown), or any combination thereof. It is contemplated that the data network may be any local area network (LAN), metropolitan area network (MAN), wide area network (WAN), a public data network (e.g., the Internet), short range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks, code division multiple access (CDMA), wideband code division multiple access (WCDMA), wireless fidelity (WiFi), wireless LAN (WLAN), Bluetooth®, Internet Protocol (IP) data casting, satellite, mobile ad-hoc network (MANET), and the like, or any combination thereof

The UE 101 is any type of mobile terminal, fixed terminal, or portable terminal including a mobile handset, station, unit, device, multimedia computer, multimedia tablet, Internet node, communicator, desktop computer, laptop computer, notebook computer, netbook computer, tablet computer, personal communication system (PCS) device, personal navigation device, personal digital assistants (PDAs), audio/video player, digital camera/camcorder, positioning device, television receiver, radio broadcast receiver, electronic book device, game device, or any combination thereof, including the accessories and peripherals of these devices, or any combination thereof. It is also contemplated that the UE 101 can support any type of interface to the user (such as “wearable” circuitry, etc.).

By way of example, the UE 101 and the server 103 communicate with each other and other components of the communication network 105 using well known, new or still developing protocols. In this context, a protocol includes a set of rules defining how the network nodes within the communication network 105 interact with each other based on information sent over the communication links. The protocols are effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model.

Communications between the network nodes are typically effected by exchanging discrete packets of data. Each packet typically comprises (1) header information associated with a particular protocol, and (2) payload information that follows the header information and contains information that may be processed independently of that particular protocol. In some protocols, the packet includes (3) trailer information following the payload and indicating the end of the payload information. The header includes information such as the source of the packet, its destination, the length of the payload, and other properties used by the protocol. Often, the data in the payload for the particular protocol includes a header and payload for a different protocol associated with a different, higher layer of the OSI Reference Model. The header for a particular protocol typically indicates a type for the next protocol contained in its payload. The higher layer protocol is said to be encapsulated in the lower layer protocol. The headers included in a packet traversing multiple heterogeneous networks, such as the Internet, typically include a physical (layer 1) header, a data-link (layer 2) header, an internetwork (layer 3) header and a transport (layer 4) header, and various application headers (layer 5, layer 6 and layer 7) as defined by the OSI Reference Model.

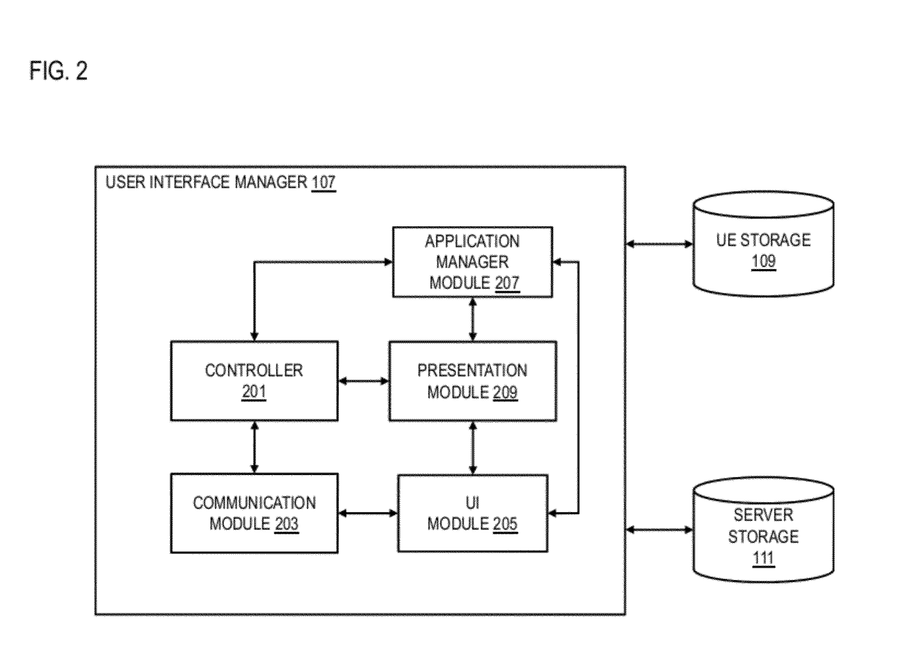

FIG. 2 is a diagram of the components of the user interface manager 107, according to one embodiment. By way of example, the user interface manager 107 includes one or more components for applying changes to a user interface. It is contemplated that the functions of these components may be combined in one or more components or performed by other components of equivalent functionality. In this embodiment, the user interface manager 107 includes a controller 201, a communication module 203, a UI module 205, an application manager module 207 and a presentation module 209, and has connectivity to the UE storage 109. The user interface manager 107 may also have connectivity to the server storage 111 via the communication network 105. The control module 201 oversees tasks, including tasks performed by the communication module 203, the UI module 205, the application manager module 207 and the presentation module 209. The communication module 203 may be used to communicate with the server 103 as well as the UE storage 109 and the server storage 111 to exchange data, such as data related to user interfaces and applications running on the user interface. The UI module 205 manages the user interface such that changes can be applied to the first user interface to generate the second user interface. The application manager module 207 manages the applications running in the user interface, and further manages data handled by the applications. The presentation module 209 may be used to present the user interface. The presentation module 209 may communicate with the UI module 205 to provide a user interface, and may also communicate with the application manager module 207 to present the applications to the user interface.

In one embodiment, the communication module 203 receives an input for specifying a change to the components of the first user interface. The input for specifying the change may be a user input to make the changes, wherein the user input may be entered via the UE 101. The input may also be a signal within the UE 101 or from the server 103 that specifies the change. For example, if there is an update available in the server 103 for the first user interface, an input may be received from the server 103 specifying the change for the update. The communication module 203 also receives user interfaces from the UE storage 109 and/or the server storage 111 and directs them to the UI module 205. Further, the communication module 203 may be used to transmit data such as status information associated with the first user interface as well as any application data to the UE storage 109 to store the information, and may also be used to retrieve the stored status information and/or the application data. Further, the components may be the functional components that are associated with various functions of the user interface. For example, the components may specify characteristics for opening, closing, minimizing, maximizing, moving, resizing, navigating, or a combination thereof one or more outputs of the one or more applications.

The UI module 205 may be used to determine to preserve respective execution states of the applications associated with the user interface. The UI module 205 may also communicate with the application manager module 207 for this determination. The execution states of the applications may be the state of the application that is opened in the user interface. One example of the execution state may be a document viewer showing a presentation slide in a landscape view. Then, the UI module 205 may apply the change specified by the input in order to generate the second user interface for presenting the one or more applications based on the preserved respective execution states. The UI module 205 may also determine the status information associated with the first user interface, and may be used to restore at least a portion of the second user interface following application of the change based on the status information. The status information may include identifiers of the applications, location and dimensional information of displays associated with the one or more applications, and status information of the windows. By restoring the second user interface based on the status information, the applications may be presented on the second user interface according to the application identifiers included in the status information, and the applications may be arranged in the second user interface according to the location and dimensional information, and the windows may also be arranged based on the status information of the windows included in the status information. Therefore, for example, if the first user interface had a document viewer application and a game application open, side by side, while having other windows minimized, then the second user interface may be restored with the same status, with the document viewer application and the game application open, side by side, while having the other windows minimized if the second user interface allows this type of layout of the document viewer application and the game application.

The UI module 205 may determine to maintain the first user interface and the second user interface concurrently. If this is the case, then the second user interface may be presented based on the execution states and/or the status information of the first user interface. However, if the first user interface and the second user interface are not maintained concurrently, the status information associated with the first user interface may need to be stored for a later use, which is for maintaining the status information after the change is made to generate the second user interface by restoring the stored status information. This is because, if the first user interface is stopped before the second user interface is started, then information associated with the first user interface and applications running in the first user interface may be lost after the first user interface is stopped. In a preferred embodiment, the time period of the first user interface and the second user interface being maintained concurrently may be a limited time period. The length of this time period may be limited by a processing power and a capacity of the UE 101. The UI module 205 may also be used to initiate a transition between the first user interface and the second user interface. The determination to initiate the transition may be based on predetermined criteria. For example, the criteria may be set such that the transition is initiated periodically (e.g. at the end of each month). As another example, the criteria may be set such that the transition is initiated whenever there is a new update for the first user interface. Further, the determination to initiate the transition may also be based on a user input, wherein a user may trigger the transition from the first user interface to the second user interface by entering a user input.

The application manager module 207 may be used to manage the applications in the user interface. The application manager module 207 may be used to execute applications and run the applications on the user interface. Also, in one embodiment, the application manager module 207 may generate notifications to the applications in response to the input for specifying the change to the first user interface. The purpose of this notification is to get the applications ready for the changes that generate the second user interface as well as the transition from the first user interface to the second user interface. For example, the notification may alert the applications to initiate an operation to modify the application based on the change specified by the input.

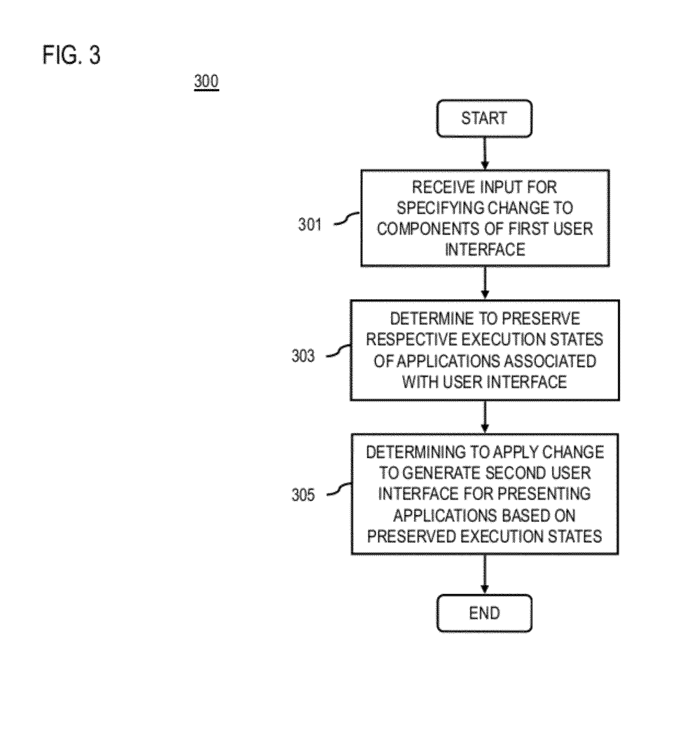

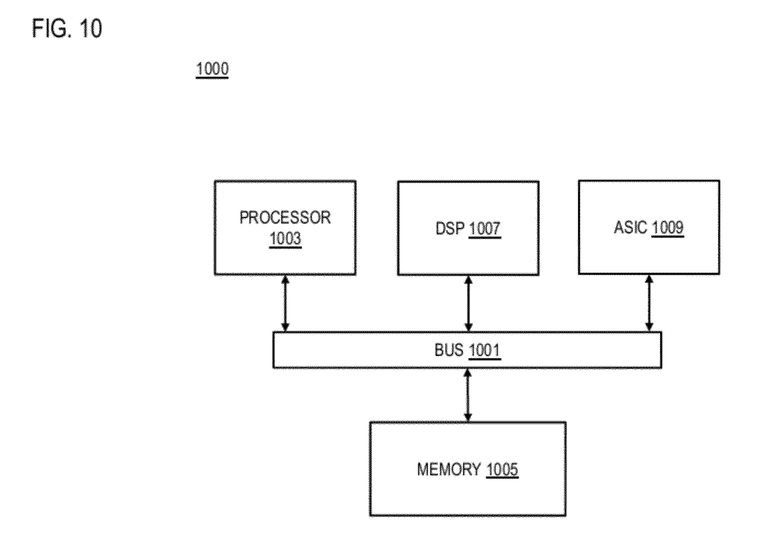

FIG. 3 is a flowchart of a process for applying changes to a user interface, according to one embodiment. In one embodiment, the user interface manager 107 performs the process 300 and is implemented in, for instance, a chip set including a processor and a memory as shown in FIG. 10. In step 301, the user interface manager 107 receiving an input for specifying at least one change to components of a first user interface. The input for specifying the change may be a signal to the user interface manager 107 to make such changes. This input may be received when the user interface manager 107 determines to initiate a transition between the first user interface and the second user interface. The user interface manager 107 may determine to initiate the transition based on predetermined criteria and/or a user input. The user input may be a user selecting an option to initiate this transition. For example, the top-level user interface may have an option to change from one user interface to another, or apply updates to the current user interface. The predetermined criteria may be the criteria that need to satisfy before the transition is initiated. For example, the user may set the criteria such that the user interface changes on the last day of each month. As another example, the user may set the criteria such that, whenever an update for the current user interface is available, the user interface manager 107 applies updates to the user interface. In addition, the components of the first user interface may include software components of the first user interface. These software components may be components related to the functions of the user interface. For example, the components may specify characteristics for opening, closing, minimizing, maximizing, moving, resizing, navigating, or a combination thereof one or more outputs of the one or more applications. In addition, the components may also specify aesthetic characteristics, such as colors and shapes of the windows, image settings for the desktop background etc. However, the functional components generally involve more processes to make changes than the aesthetic components because the functional components tend to be more complicated than the aesthetic components.

In step 303, the user interface manager 107 determines to preserve respective execution states of applications associated with the user interface. These applications are generally the applications that are running in the user interface. The execution state of the application may be information as to the current state of the application executed under the user interface. For example, a picture viewer displaying “Image1.jpg” may be considered an execution state. As another example, a poker game that is running at a “difficult” level may be considered an execution state of the poker game application. As another example, a document editor that has an essay open may be considered an execution state of the document editor application. It is beneficial to preserve the respective execution state of the applications to minimize interruption to the user when changes are made to the first user interface. For example, if the execution state is preserved, then the interruption from editing the essay using the document editor application may be minimized. Then, in step 305, the user interface manager 107 determines to apply the at least one change to generate a second user interface for presenting the applications based on the preserved respective execution states. The change may be updates to the first user interface, thus generating the second user interface that is an updated version of the first user interface. The change may also cause the first user interface to change to a second user interface that is a completely different user interface.

This process is advantageous in that it provides a way to make changes to the first user interface to generate the second user interface while minimizing interruption in use of the application by preserving the execution states of the applications. There is an additional benefit of this process in that the system or the applications do not need to be restarted to make the changes. The user interface manager 107 is a means for achieving this advantage.

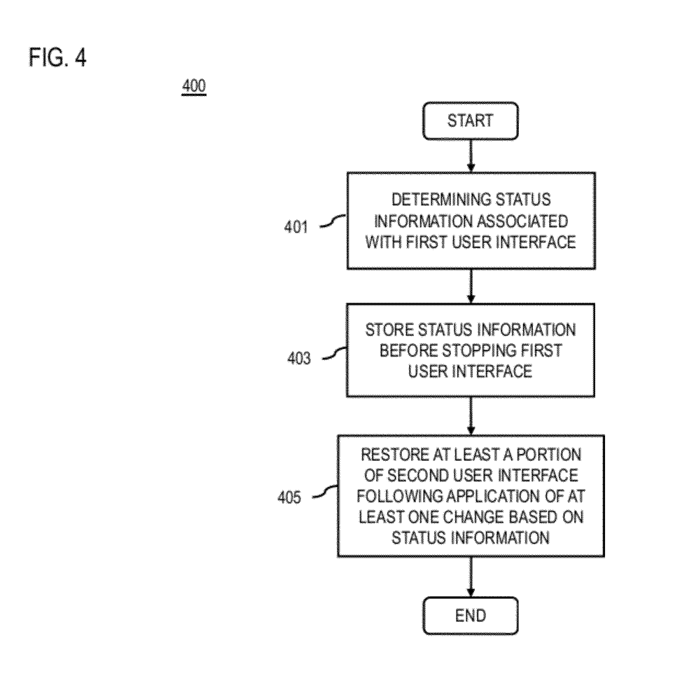

FIG. 4 is a flowchart of a process 400 for utilizing the status information of the user interface, according to one embodiment. In step 401, the user interface manager 107 determines status information associated with first user interface. The status information includes information about the state of the user interface. The status information includes identifiers of the respective applications, location and dimensional information of displays associated with the applications, and status information of the windows. The status information associated with the first user interface is different from the execution states of the applications in that the status information does not have information about current states of the applications, although it may include application identifiers. The identifiers of the applications may be identifiers unique to respective applications, and thus provide information as to which applications are running in the user interface. The location and dimensional information of the displays associated with the applications shows how the applications are displayed in the user interface, and may also include information as to how the applications are placed on the user interface in terms of their location and the size of the windows displaying the applications. The status information of the windows may include the sizes of the windows, locations of the windows, information as to whether the windows are minimized or maximized, etc.

Then, in step 403, the user interface manager 107 stores status information before stopping first user interface. The status information may be stored at the UE storage 109 or may be stored in a temporary cache. Then, in step 405, the user interface manager 107 restores at least a portion of second user interface following application of at least one change based on this status information. Storing of the status information may not be necessary if the first user interface and the second user interface exist concurrently. In that case, second user interface may be restored based on the status information determined based on the concurrently existing first user interface. However, if the first user interface is stopped before the second user interface is started, the status information may need to be stored (e.g. via step 403) because the status information of the first user interface may not be available after the first user interface is stopped.

Further, in one embodiment, the user interface manager 107 may determine to generate a notification to at least one of the applications in response to the input for specifying the change to the components of the first user interface. This notification serves as a signal to the applications to prepare for applications of changes to the first user interface. In one embodiment, the notification may alert the applications to initiate an operation to modify the at least one application based on the at least one change. For example, if applying the changes to generate the second user interface results in changes in the dimensions and the locations of the applications, the notification may be generated and sent to the applications such that the application may be properly adapted to the changes.

This process is advantageous in that it provides a way to preserve the status information associated with the first user interface such that the same or similar status can be restored at the second user interface, which is another way to minimize interruption in using the user interface. The user interface manager 107 is a means for achieving this advantage.

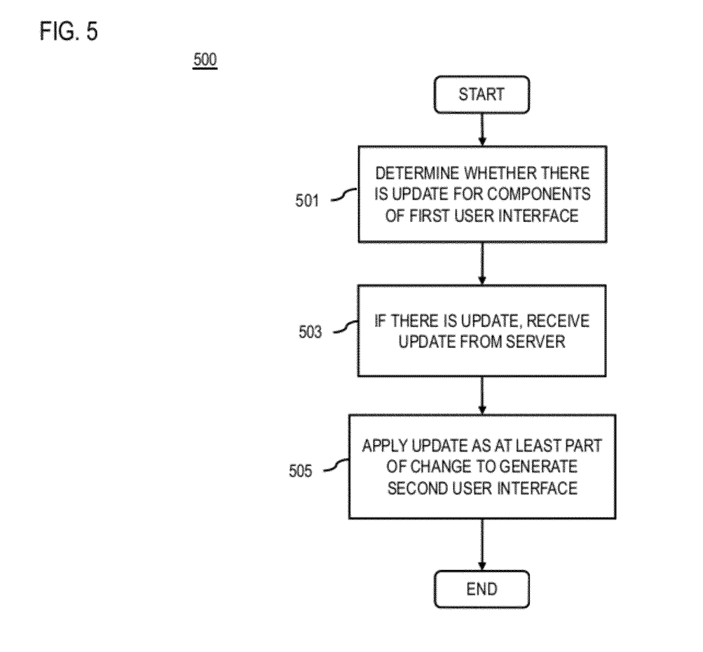

FIG. 5 is a flowchart of a process 500 for applying an update to the user interface, according to one embodiment. In step 501, the user interface manager 107 determines whether there is an update for the components of the first user interface. The update may be provided by the server 103. For example, a manufacturer of the UE 101 may upload the update for a user interface to the server 103. Then, in step 503, the user interface manager 107 receives the update from the server 103 if there is an update for the first user interface. In one example, the criteria can be set such that the update for the first user interface is received as soon as a new update becomes available. The update may also be received from the server 103 as a push operation from the server 103. In step 505, the user interface manager 107 applies the update as at least a part of a change to generate the second user interface. Then, the second user interface may be an updated version of the first user interface, after the update is applied.

This process is advantageous in that it applies an update to the user interface whenever there is a new update available for the user interface. The user interface manager 107 is a means for achieving this advantage.

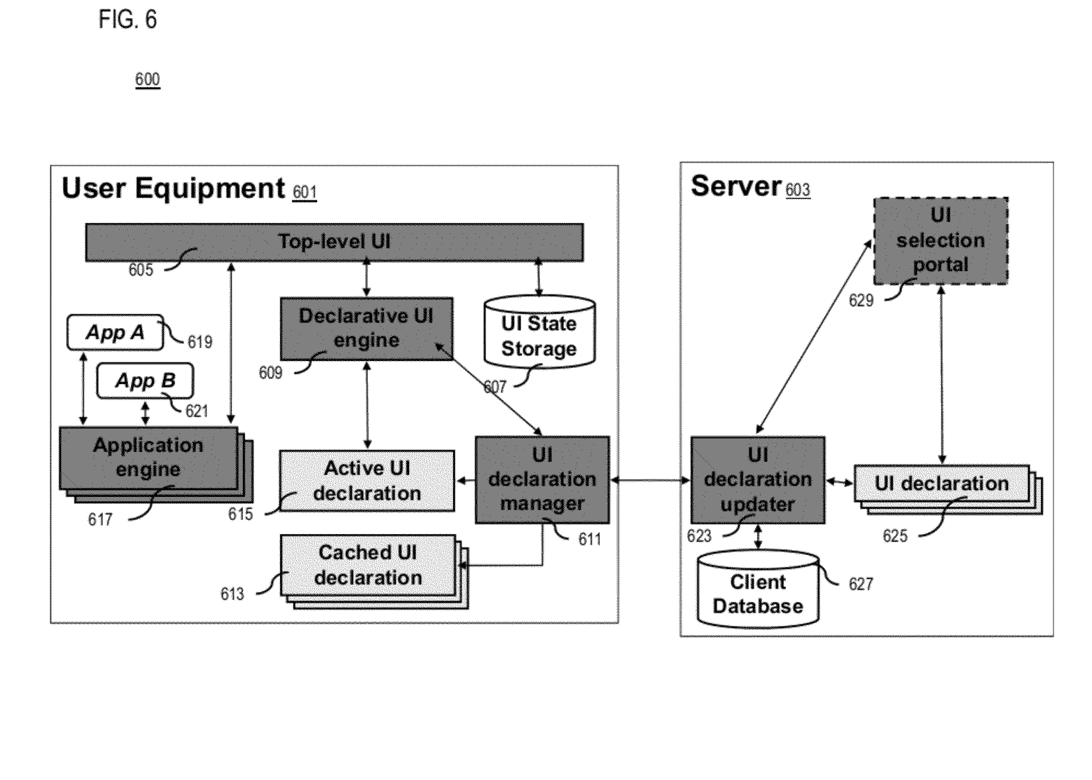

FIG. 6 is a diagram 600 showing components of the UE and the server, and interactions thereof, according to one embodiment of the invention. The UE 601 and the server 603 may be equivalent to the UE 101 and the server 103. The UE 601 includes a top-level UI 605. The top-level UI 605 enables operations for windows in the top-level UI, the operations including opening, closing, minimizing, maximizing, moving, resizing, and etc., and keeps track of running windows. A simple top-level UI 605 may be capable of showing only one or two of the running applications at once. In this case, for example, this simple top-level UI may be capable off showing one application on the foreground, while maintaining the other applications in the background and enabling a user to switch any one of the other applications in the background with the application on the foreground. More complex top-level UI 605 may be able to show multiple running applications at the same time on the foreground. Further, more complex top-level UI 605 may operate multiple windows associated with multiple applications running separately.

The top-level UI 605 may communicate with the UI state storage 607 to store information about the UI status, especially when the top-level UI 605 is about to close or experience changes. Then, when the top-level UI 605 is opened (e.g. after changes are applied to the top-level UI 605), the state are restored to the state of the applications and windows and any other settings, according to the stored UI status. The UI status may include application identifiers of the running applications as well as location and dimensional information of displays associated with the one or more applications, and status information of the windows (e.g. minimize/maximize state of the windows, arrangements of the windows as well as size, shape and location of the windows). Thus, for example, the state may be restored to show the windows with the same applications, and same or similar dimensions and locations of the windows that correspond to the state of the top-level UI, according to the stored UI status.

The UI state storage 607 may maintain multiple UI statuses in different parts for each application. The status types that a top-level UI can utilize read when the top-level UI starts. Changes to the status of the utilized status types are stored when the top-level UI exits. Other status types that a top-level UI cannot utilize remain in the storage 607 unchanged when the top-level UI is active. Then, if another top-level UI that can utilize the other status types starts, then the other status types may be read from the storage 607 when the other top-level UI starts. For example, the UI state storage 607 may store status type A corresponding to window positions, status type B for the order of the window (i.e. which window is on top of which window, wherein the window on the very top being the active window) and status type C for the size of the windows. When considering a case where the top-level UI type 1 is switched to the top-level UI type 2 and then switched to the top-level UI type 3, different types of the top-level UI may utilize all or only some of the status types. In this example, if the top-level UI type 2 does not utilize the status type A because the top-level UI type 2 only allows one size for all the windows, only the status type B from the top-level UI type 1 is restored when switching to the top-level UI type 2. Then, when switching from the top-level UI type 2 to the top-level UI type 3, if the top-level UI type 3 is able to utilize the status types A, B and C, then the status type A stored by the top-level UI type 1 is restored and the status type B and the status type C stored by the top-level UI type 2 are also restored.

The declarative UI engine 609 creates and/or maintains the top-level UI 605 based on currently active UI declaration. The declarative UI engine 609 may communicate with the UI declaration manager 611 to perform operations related to the UI declaration. The UI declaration manager 611 may cache the UI declarations received from the server 603. The cached UI declaration 613 may be utilized immediately when a request to change the top-level UI 605 is received. The UI declaration manager 611 may also select the currently active UI declaration 615 from a cached UI declaration 613. The declarative UI engine 609 and the UI declaration manager 611 may be a part of the UI module 205 of the user interface manager 107.

Each UI declaration has a globally unique identifier such as the URL from which the UI declaration can be downloaded from. Each UI declaration may also have a version number. Then, a new version of the UI declaration may be identified. Especially if only one version of each UI declaration is maintained in the client and in the server, a version may be identified to maintain the newest version of the UI declaration.

The active UI declaration 615 is the declaration of currently active top-level UI. The UI declaration manager 611 may be used to change the active UI declaration. For example, the top-level user interface based on the active UI declaration before the change may correspond to the first user interface, and the top-level user interface based on the active UI declaration after the change may correspond to the second user interface. The cached UI declaration 613 is a UI declaration that is stored and is not a currently active UI declaration. If different declarations are cached, then these cached declarations may be accessed to switch to one of the cached declarations, when changing the top-level UI 605. The cached declaration 613 provides a quick way to change the top-level UI 605 because the declaration does not need to be downloaded from the server 603. Further, if the device is in an offline setting or outside a network coverage, only the cached declaration 613 may be accessible, because other declarations cannot be downloaded from the server 603.

An Application engine 617 may be used by the top-level UI 605 to execute applications. Examples of the application engine 617 may include a web browser, java virtual machine, and Python interpreter. The application engine 617 can start an application, such as App A 619 and App B 621. The application may be started based on an application pointer (e.g. file name, URL, etc.) provided by the top-level UI 605. The application engine 617 may also return to the top-level UI 605 a reference to an application running in the top-level UI 605. The reference may be the application identifiers to the top-level UI 605. As discussed previously, the top-level UI 605 may store the application identifiers in the UI state storage 607, and then may use the stored application identifiers UI status information that can be used to restore the applications to the state before changes are applied to the top-level UI 605. The application engine 617 may also close an application based on the corresponding application identifier, if instructed by the top-level UI 605. Further, the application engine 617 may show or hide an application. The application engine 617 may be a part of the application manager module 207 of the user interface manager 107.

The applications such as App A 619 and App B 621 may be capable of operating independently from the top-level UI 605. However, there still may be some communication between the top-level UI 605 and the applications. For example, the UI declaration manager 611 may provide a notification API for the applications, wherein the API enables the applications to receive a notification from the UI declaration manager 611. The notification may be received from the UI declaration manager 611 when the top-level UI changes (e.g. applications adapting to a top-level UI color scheme), when application window dimensions and/or locations change (and thus possibly causing the applications to redraw), and when the device orientation changes (e.g. rotating the device to view the device as a landscape view) such that the applications may need to change to adapt to the device orientation.

The server 603 may be a server maintained by a manufacturer of the UE 601 or may be maintained by another independent entity. The server 603 may include an UI declaration updater 623 which is capable of sending the UI declaration 625 to the UE 601 based on the request from the UI declaration manager 611. The UI declaration updater 623 may also be able to push the UI declaration 625 without the request from the UE 601. For example, when the UI declaration updater 623 may determine that a new version of the UI declaration is available, the UI declaration updater 623 may push the new version of the UI declaration to the UI declaration manager 611. The UI declaration updater 623 may also manage the transmission of the UI declaration 625. For example, if a large number of UI declarations need to be sent to a large number of devices, then the UI declaration updater 623 may manage traffic of the transmission (i.e. five UI declarations are to be sent at a time). The server is generally capable of storing a large amount of the UI declarations 625. The UI declarations 625 may be provided by the device manufacturer, an operator of the communication network or even the users themselves.

The UI declaration updater 623 may be connected the client database 627. The client database 627 may store information related to the clients (e.g. a user using the UE 601). For example, the client database 627 may include information about which clients have which UI declaration. The UI declaration updater 623 is able to keep the client database 627 up to date with such information, as the UI declaration updater sends the UI declaration to the UI declaration manager 611 and thus has information about which UI declaration is being sent to which client's UI declaration manager 611.

The server 603 may also have a UI selection portal 629, which may be an interface that allows the user to browse available UI declarations and download UIs via a web interface. The UI selection portal 629 may also be used to configure whether to have the server 603 push the UI declaration, and the manner of the push operation (e.g. push whenever an updated UI declaration is available, push once a year, etc.).

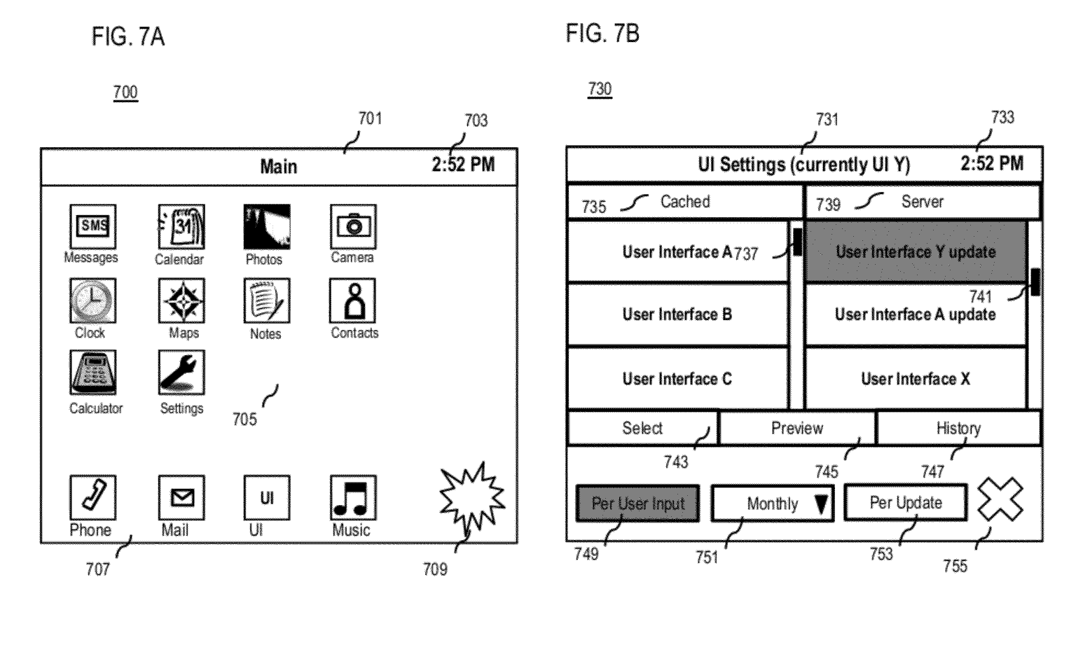

FIGS. 7A-7B are diagrams of user interfaces utilized in the processes of FIG. 3, according to one embodiment of the invention. FIG. 7A shows one example of a user interface 700 for the main screen. The title 701 shows that the user interface shows a main screen. The title 701 also has a current time 703. The main section has icons for various applications and functions, wherein the icons are selectable to execute the corresponding applications and functions. The favorites section 705 shows four favorite icons, including a phone application, a mail application, a user interface application, and a music application. The update notification 709 appears on the user interface whenever there is a new update for the user interface. If this update notification 709 is selected, then the user interface opens a window showing a user interface settings, as shown in FIG. 7B. FIG. 7B shows a user interface 730 for applying changes to the current user interface. The title window 731 shows that the user interface 730 is for a user interface settings, and also shows that the currently used user interface is User Interface Y. The title window 731 also shows the current time 733. The cached UI declaration list 735 lists the UI declarations that are available in the cache (e.g. the UE storage), and has a scroll bar 737 to scroll up and down the list. The server user interface list 739 shows the UI declarations and updates to user interfaces that are available in the server 103. The server user interface list 739 also has a scroll bar 741 to scroll up and down the list. The select button 743 is used to select a UI declaration or a user interface update (from the cached UI declaration list or the server UI declaration list) for the change of the user interface. In this case, the user has selected the user interface Y update. The preview button 745 may be selected to preview the user interface, such that the user can determine based on the preview whether to use the user interface corresponding to the selected UI declaration or update. The history button 749 shows a history of changes in the user interface. Further, the per user input option 749 may be selected to initiate a transition between the current user interface to the selected user interface (or an updated user interface) based on the user input. If the time option 751 is selected to initiate the transition, the transition is made periodically among the available user interfaces. The per update option 753 may be selected to initiate the transition whenever there a new update available for the current user interface. In this case, the per user input option 749 is selected, and thus the transition will be made upon a user input. The exit button 755 exits to the main screen.

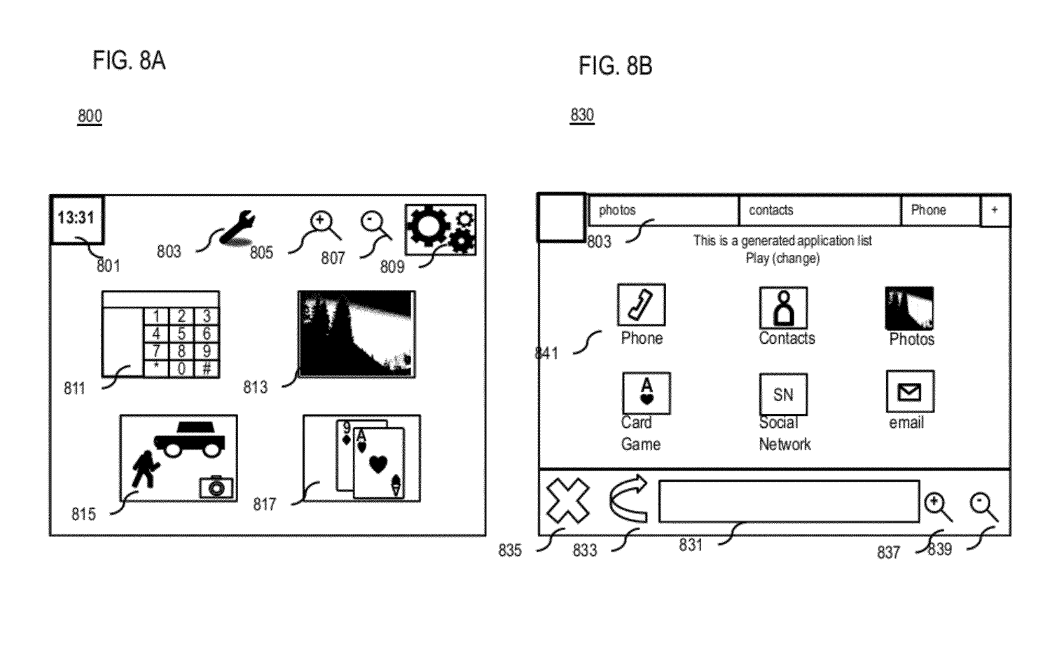

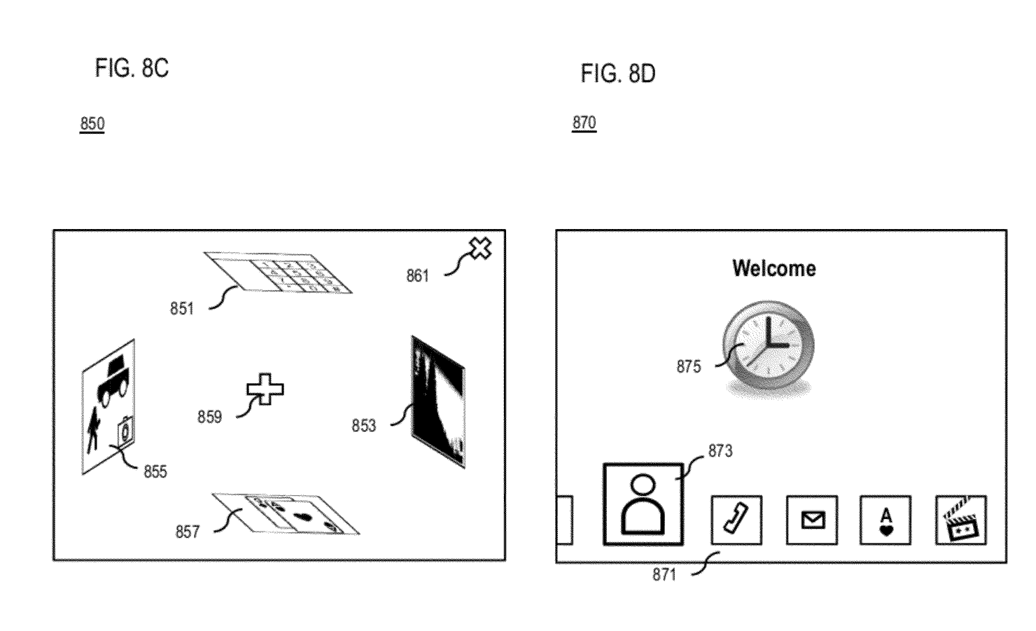

FIGS. 8A-8D are examples of user interfaces that can be used as an interface for the UE 101, according to various embodiments. FIG. 8A shows a user interface 800 that may be zoomable and/or pannable in two dimensions. This user interface shows a clock 801 showing a current time, a user interface setting icon 803 that can be selected to show settings for changing the user interface, the zoom in icon 805 and the zoom out icon $07 to zoom in and out in the user interface. The settings button 809 may be selected to show settings for the UE 101. This example has four windows with four applications. The first window 811, the second window 813, the third window 815 and the fourth window 817 show a calculator, a picture viewer, a picture taker via a camera, and a poker game. These windows are presented in a two dimensional format. FIG. 8B shows a user interface 830 that is centered around a web browser. The URL address bar 831 may be used to enter an internet address. When the internet address is entered, then a web browser will be opened to access the internet address. The refresh button 833 may be used to refresh the web browser, and the stop button 835 may be used to stop accessing the internet address. The user interface 830 also has the zoom in icon 837 and the zoom out icon $39 to zoom in and out in the user interface. The main screen 841 has icons that can be selected to open applications corresponding to the icons. In this example, the main screen 841 shows icons for a phone, contacts, a photo viewer, a card game, a social networking application and an email application. The favorites bar 843 shows the user's favorite applications. In this example, the favorites bar 843 shows the photo viewer, the contacts and the phone as the user's favorite applications.

FIG. 8C shows a user interface 850 that has a three-dimensional rendering of windows. The first window 851, the second window 853, the third window 855 and the fourth window 857 show a calculator, a picture viewer, a picture taker via a camera, and a poker game. These windows are arranged automatically. The center button 859 may be selected to open a new application. One of the first window 851, the second window 853, the third window 855 and the fourth window 857 may be selected to show the application corresponding to the selected one is displayed in full screen on the user interface 850. The close button 861 may be selected to close the application in full screen, and return to the top-level user interface as shown in the user interface 850. FIG. 8D shows a user interface 870 that has a fixed, predefined set of applications. Application launcher 871 is always visible at the bottom of screen, and lists the icons corresponding to applications. The selected icon 873 representing a selected application is bigger than other icons. The user interface 870 also shows a clock 875 showing the current time.

The processes described herein for applying changes to a user interface may be advantageously implemented via software, hardware, firmware or a combination of software and/or firmware and/or hardware. For example, the processes described herein, may be advantageously implemented via processor(s), Digital Signal Processing (DSP) chip, an Application Specific Integrated Circuit (ASIC), Field Programmable Gate Arrays (FPGAs), etc. Such exemplary hardware for performing the described functions is detailed below.

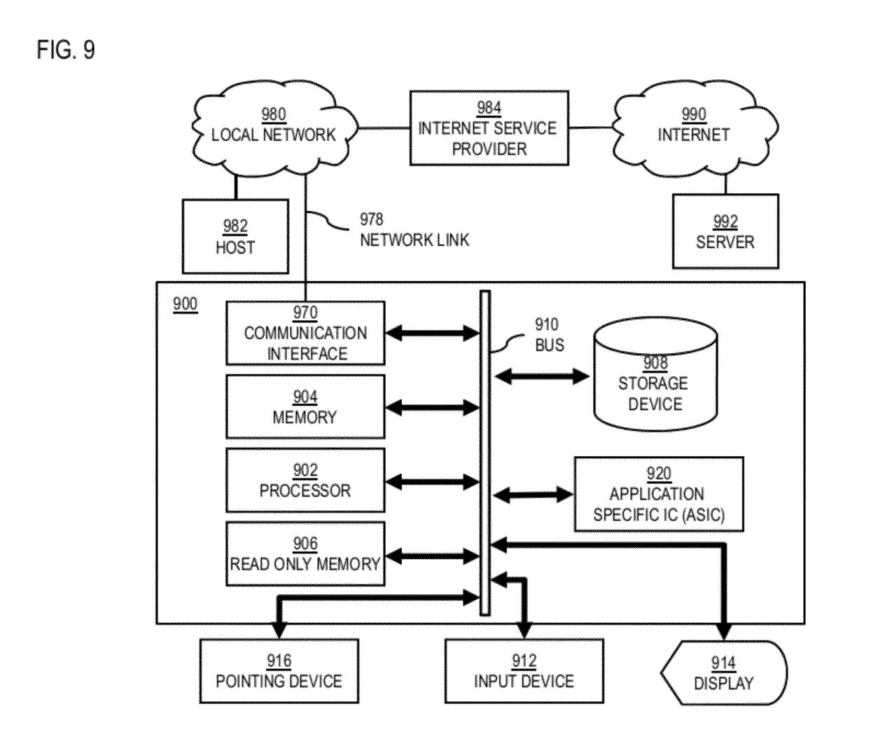

FIG. 9 illustrates a computer system 900 upon which an embodiment of the invention may be implemented. Although computer system 900 is depicted with respect to a particular device or equipment, it is contemplated that other devices or equipment (e.g., network elements, servers, etc.) within FIG. 9 can deploy the illustrated hardware and components of system 900. Computer system 900 is programmed (e.g., via computer program code or instructions) to apply changes to a user interface as described herein and includes a communication mechanism such as a bus 910 for passing information between other internal and external components of the computer system 900. Information (also called data) is represented as a physical expression of a measurable phenomenon, typically electric voltages, but including, in other embodiments, such phenomena as magnetic, electromagnetic, pressure, chemical, biological, molecular, atomic, sub-atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range. Computer system 900, or a portion thereof, constitutes a means for performing one or more steps of applying changes to a user interface.

A bus 910 includes one or more parallel conductors of information so that information is transferred quickly among devices coupled to the bus 910. One or more processors 902 for processing information are coupled with the bus 910.

A processor (or multiple processors) 902 performs a set of operations on information as specified by computer program code related to applying changes to a user interface. The computer program code is a set of instructions or statements providing instructions for the operation of the processor and/or the computer system to perform specified functions. The code, for example, may be written in a computer programming language that is compiled into a native instruction set of the processor. The code may also be written directly using the native instruction set (e.g., machine language). The set of operations include bringing information in from the bus 910 and placing information on the bus 910. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 902, such as a sequence of operation codes, constitute processor instructions, also called computer system instructions or, simply, computer instructions. Processors may be implemented as mechanical, electrical, magnetic, optical, chemical or quantum components, among others, alone or in combination.

Computer system 900 also includes a memory 904 coupled to bus 910. The memory 904, such as a random access memory (RAM) or any other dynamic storage device, stores information including processor instructions for applying changes to a user interface. Dynamic memory allows information stored therein to be changed by the computer system 900. RAM allows a unit of information stored at a location called a memory address to be stored and retrieved independently of information at neighboring addresses. The memory 904 is also used by the processor 902 to store temporary values during execution of processor instructions. The computer system 900 also includes a read only memory (ROM) 906 or any other static storage device coupled to the bus 910 for storing static information, including instructions, that is not changed by the computer system 900. Some memory is composed of volatile storage that loses the information stored thereon when power is lost. Also coupled to bus 910 is a non-volatile (persistent) storage device 908, such as a magnetic disk, optical disk or flash card, for storing information, including instructions, that persists even when the computer system 900 is turned off or otherwise loses power.

Information, including instructions for applying changes to a user interface, is provided to the bus 910 for use by the processor from an external input device 912, such as a keyboard containing alphanumeric keys operated by a human user, or a sensor. A sensor detects conditions in its vicinity and transforms those detections into physical expression compatible with the measurable phenomenon used to represent information in computer system 900. Other external devices coupled to bus 910, used primarily for interacting with humans, include a display device 914, such as a cathode ray tube (CRT), a liquid crystal display (LCD), a light emitting diode (LED) display, an organic LED (OLED) display, a plasma screen, or a printer for presenting text or images, and a pointing device 916, such as a mouse, a trackball, cursor direction keys, or a motion sensor, for controlling a position of a small cursor image presented on the display 914 and issuing commands associated with graphical elements presented on the display 914. In some embodiments, for example, in embodiments in which the computer system 900 performs all functions automatically without human input, one or more of external input device 912, display device 914 and pointing device 916 is omitted.

In the illustrated embodiment, special purpose hardware, such as an application specific integrated circuit (ASIC) 920, is coupled to bus 910. The special purpose hardware is configured to perform operations not performed by processor 902 quickly enough for special purposes. Examples of ASICs include graphics accelerator cards for generating images for display 914, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 900 also includes one or more instances of a communications interface 970 coupled to bus 910. Communication interface 970 provides a one-way or two-way communication coupling to a variety of external devices that operate with their own processors, such as printers, scanners and external disks. In general the coupling is with a network link 978 that is connected to a local network 980 to which a variety of external devices with their own processors are connected. For example, communication interface 970 may be a parallel port or a serial port or a universal serial bus (USB) port on a personal computer. In some embodiments, communications interface 970 is an integrated services digital network (ISDN) card or a digital subscriber line (DSL) card or a telephone modem that provides an information communication connection to a corresponding type of telephone line. In some embodiments, a communication interface 970 is a cable modem that converts signals on bus 910 into signals for a communication connection over a coaxial cable or into optical signals for a communication connection over a fiber optic cable. As another example, communications interface 970 may be a local area network (LAN) card to provide a data communication connection to a compatible LAN, such as Ethernet. Wireless links may also be implemented. For wireless links, the communications interface 970 sends or receives or both sends and receives electrical, acoustic or electromagnetic signals, including infrared and optical signals, that carry information streams, such as digital data. For example, in wireless handheld devices, such as mobile telephones like cell phones, the communications interface 970 includes a radio band electromagnetic transmitter and receiver called a radio transceiver. In certain embodiments, the communications interface 970 enables connection to the communication network 105 for applying changes to a user interface.

The term “computer-readable medium” as used herein refers to any medium that participates in providing information to processor 902, including instructions for execution. Such a medium may take many forms, including, but not limited to computer-readable storage medium (e.g., non-volatile media, volatile media), and transmission media. Non-transitory media, such as non-volatile media, include, for example, optical or magnetic disks, such as storage device 908. Volatile media include, for example, dynamic memory 904. Transmission media include, for example, twisted pair cables, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, an EEPROM, a flash memory, any other memory chip or cartridge, a carrier wave, or any other medium from which a computer can read. The term computer-readable storage medium is used herein to refer to any computer-readable medium except transmission media.

Logic encoded in one or more tangible media includes one or both of processor instructions on a computer-readable storage media and special purpose hardware, such as ASIC 920.

Network link 978 typically provides information communication using transmission media through one or more networks to other devices that use or process the information. For example, network link 978 may provide a connection through local network 980 to a host computer 982 or to equipment 984 operated by an Internet Service Provider (ISP). ISP equipment 984 in turn provides data communication services through the public, world-wide packet-switching communication network of networks now commonly referred to as the Internet 990.

A computer called a server host 992 connected to the Internet hosts a process that provides a service in response to information received over the Internet. For example, server host 992 hosts a process that provides information representing video data for presentation at display 914. It is contemplated that the components of system 900 can be deployed in various configurations within other computer systems, e.g., host 982 and server 992.

At least some embodiments of the invention are related to the use of computer system 900 for implementing some or all of the techniques described herein. According to one embodiment of the invention, those techniques are performed by computer system 900 in response to processor 902 executing one or more sequences of one or more processor instructions contained in memory 904. Such instructions, also called computer instructions, software and program code, may be read into memory 904 from another computer-readable medium such as storage device 908 or network link 978. Execution of the sequences of instructions contained in memory 904 causes processor 902 to perform one or more of the method steps described herein. In alternative embodiments, hardware, such as ASIC 920, may be used in place of or in combination with software to implement the invention. Thus, embodiments of the invention are not limited to any specific combination of hardware and software, unless otherwise explicitly stated herein.

The signals transmitted over network link 978 and other networks through communications interface 970, carry information to and from computer system 900. Computer system 900 can send and receive information, including program code, through the networks 980, 990 among others, through network link 978 and communications interface 970. In an example using the Internet 990, a server host 992 transmits program code for a particular application, requested by a message sent from computer 900, through Internet 990, ISP equipment 984, local network 980 and communications interface 970. The received code may be executed by processor 902 as it is received, or may be stored in memory 904 or in storage device 908 or any other non-volatile storage for later execution, or both. In this manner, computer system 900 may obtain application program code in the form of signals on a carrier wave.

Various forms of computer readable media may be involved in carrying one or more sequence of instructions or data or both to processor 902 for execution. For example, instructions and data may initially be carried on a magnetic disk of a remote computer such as host 982. The remote computer loads the instructions and data into its dynamic memory and sends the instructions and data over a telephone line using a modem. A modem local to the computer system 900 receives the instructions and data on a telephone line and uses an infra-red transmitter to convert the instructions and data to a signal on an infra-red carrier wave serving as the network link 978. An infrared detector serving as communications interface 970 receives the instructions and data carried in the infrared signal and places information representing the instructions and data onto bus 910. Bus 910 carries the information to memory 904 from which processor 902 retrieves and executes the instructions using some of the data sent with the instructions. The instructions and data received in memory 904 may optionally be stored on storage device 908, either before or after execution by the processor 902.

FIG. 10 illustrates a chip set or chip 1000 upon which an embodiment of the invention may be implemented. Chip set 1000 is programmed to apply changes to a user interface as described herein and includes, for instance, the processor and memory components described with respect to FIG. 9 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set 1000 can be implemented in a single chip. It is further contemplated that in certain embodiments the chip set or chip 1000 can be implemented as a single “system on a chip.” It is further contemplated that in certain embodiments a separate ASIC would not be used, for example, and that all relevant functions as disclosed herein would be performed by a processor or processors. Chip set or chip 1000, or a portion thereof, constitutes a means for performing one or more steps of providing user interface navigation information associated with the availability of functions. Chip set or chip 1000, or a portion thereof, constitutes a means for performing one or more steps of applying changes to a user interface.

In one embodiment, the chip set or chip 1000 includes a communication mechanism such as a bus 1001 for passing information among the components of the chip set 1000. A processor 1003 has connectivity to the bus 1001 to execute instructions and process information stored in, for example, a memory 1005. The processor 1003 may include one or more processing cores with each core configured to perform independently. A multi-core processor enables multiprocessing within a single physical package. Examples of a multi-core processor include two, four, eight, or greater numbers of processing cores. Alternatively or in addition, the processor 1003 may include one or more microprocessors configured in tandem via the bus 1001 to enable independent execution of instructions, pipelining, and multithreading. The processor 1003 may also be accompanied with one or more specialized components to perform certain processing functions and tasks such as one or more digital signal processors (DSP) 1007, or one or more application-specific integrated circuits (ASIC) 1009. A DSP 1007 typically is configured to process real-world signals (e.g., sound) in real time independently of the processor 1003. Similarly, an ASIC 1009 can be configured to performed specialized functions not easily performed by a more general purpose processor. Other specialized components to aid in performing the inventive functions described herein may include one or more field programmable gate arrays (FPGA) (not shown), one or more controllers (not shown), or one or more other special-purpose computer chips.

In one embodiment, the chip set or chip 1000 includes merely one or more processors and some software and/or firmware supporting and/or relating to and/or for the one or more processors.

The processor 1003 and accompanying components have connectivity to the memory 1005 via the bus 1001. The memory 1005 includes both dynamic memory (e.g., RAM, magnetic disk, writable optical disk, etc.) and static memory (e.g., ROM, CD-ROM, etc.) for storing executable instructions that when executed perform the inventive steps described herein to apply changes to a user interface. The memory 1005 also stores the data associated with or generated by the execution of the inventive steps.

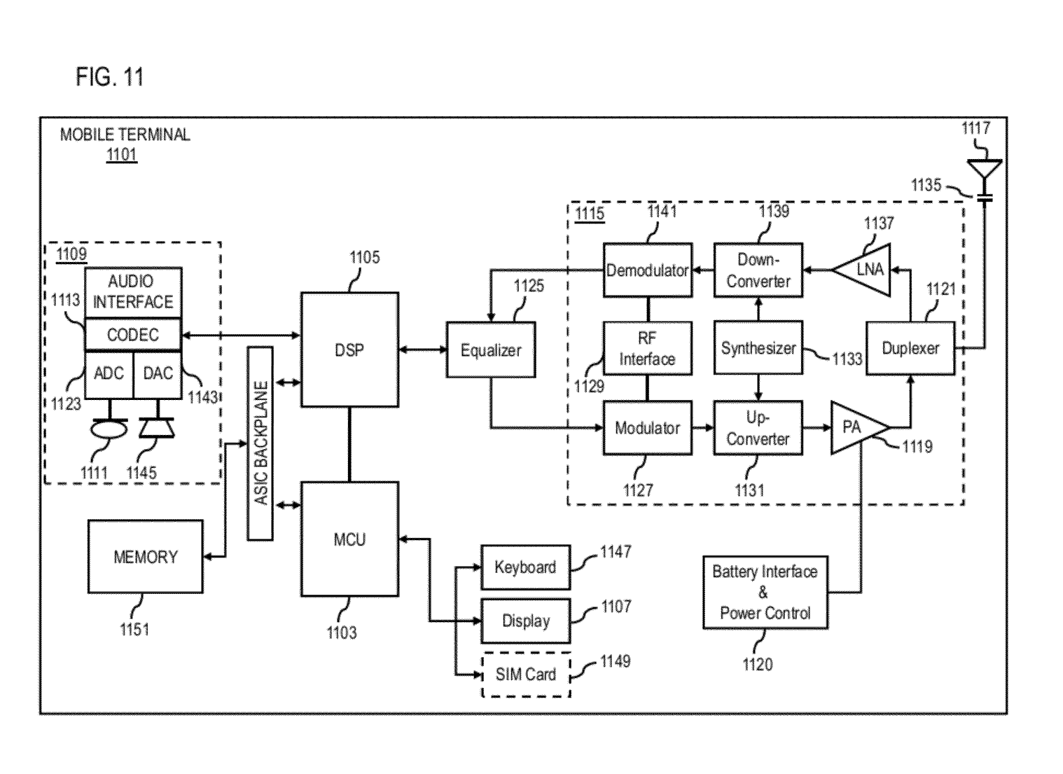

FIG. 11 is a diagram of exemplary components of a mobile terminal (e.g., handset) for communications, which is capable of operating in the system of FIG. 1, according to one embodiment. In some embodiments, mobile terminal 1101, or a portion thereof, constitutes a means for performing one or more steps of applying changes to a user interface. Generally, a radio receiver is often defined in terms of front-end and back-end characteristics. The front-end of the receiver encompasses all of the Radio Frequency (RF) circuitry whereas the back-end encompasses all of the base-band processing circuitry. As used in this application, the term “circuitry” refers to both: (1) hardware-only implementations (such as implementations in only analog and/or digital circuitry), and (2) to combinations of circuitry and software (and/or firmware) (such as, if applicable to the particular context, to a combination of processor(s), including digital signal processor(s), software, and memory(ies) that work together to cause an apparatus, such as a mobile phone or server, to perform various functions). This definition of “circuitry” applies to all uses of this term in this application, including in any claims. As a further example, as used in this application and if applicable to the particular context, the term “circuitry” would also cover an implementation of merely a processor (or multiple processors) and its (or their) accompanying software/or firmware. The term “circuitry” would also cover if applicable to the particular context, for example, a baseband integrated circuit or applications processor integrated circuit in a mobile phone or a similar integrated circuit in a cellular network device or other network devices.

Pertinent internal components of the telephone include a Main Control Unit (MCU) 1103, a Digital Signal Processor (DSP) 1105, and a receiver/transmitter unit including a microphone gain control unit and a speaker gain control unit. A main display unit 1107 provides a display to the user in support of various applications and mobile terminal functions that perform or support the steps of applying changes to a user interface. The display 1107 includes display circuitry configured to display at least a portion of a user interface of the mobile terminal (e.g., mobile telephone). Additionally, the display 1107 and display circuitry are configured to facilitate user control of at least some functions of the mobile terminal. An audio function circuitry 1109 includes a microphone 1111 and microphone amplifier that amplifies the speech signal output from the microphone 1111. The amplified speech signal output from the microphone 1111 is fed to a coder/decoder (CODEC) 1113.

A radio section 1115 amplifies power and converts frequency in order to communicate with a base station, which is included in a mobile communication system, via antenna 1117. The power amplifier (PA) 1119 and the transmitter/modulation circuitry are operationally responsive to the MCU 1103, with an output from the PA 1119 coupled to the duplexer 1121 or circulator or antenna switch, as known in the art. The PA 1119 also couples to a battery interface and power control unit 1120.

In use, a user of mobile terminal 1101 speaks into the microphone 1111 and his or her voice along with any detected background noise is converted into an analog voltage. The analog voltage is then converted into a digital signal through the Analog to Digital Converter (ADC) 1123. The control unit 1103 routes the digital signal into the DSP 1105 for processing therein, such as speech encoding, channel encoding, encrypting, and interleaving. In one embodiment, the processed voice signals are encoded, by units not separately shown, using a cellular transmission protocol such as enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, code division multiple access (CDMA), wideband code division multiple access (WCDMA), wireless fidelity (WiFi), satellite, and the like, or any combination thereof

The encoded signals are then routed to an equalizer 1125 for compensation of any frequency-dependent impairments that occur during transmission though the air such as phase and amplitude distortion. After equalizing the bit stream, the modulator 1127 combines the signal with a RF signal generated in the RF interface 1129. The modulator 1127 generates a sine wave by way of frequency or phase modulation. In order to prepare the signal for transmission, an up-converter 1131 combines the sine wave output from the modulator 1127 with another sine wave generated by a synthesizer 1133 to achieve the desired frequency of transmission. The signal is then sent through a PA 1119 to increase the signal to an appropriate power level. In practical systems, the PA 1119 acts as a variable gain amplifier whose gain is controlled by the DSP 1105 from information received from a network base station. The signal is then filtered within the duplexer 1121 and optionally sent to an antenna coupler 1135 to match impedances to provide maximum power transfer. Finally, the signal is transmitted via antenna 1117 to a local base station. An automatic gain control (AGC) can be supplied to control the gain of the final stages of the receiver. The signals may be forwarded from there to a remote telephone which may be another cellular telephone, any other mobile phone or a land-line connected to a Public Switched Telephone Network (PSTN), or other telephony networks.

Voice signals transmitted to the mobile terminal 1101 are received via antenna 1117 and immediately amplified by a low noise amplifier (LNA) 1137. A down-converter 1139 lowers the carrier frequency while the demodulator 1141 strips away the RF leaving only a digital bit stream. The signal then goes through the equalizer 1125 and is processed by the DSP 1105. A Digital to Analog Converter (DAC) 1143 converts the signal and the resulting output is transmitted to the user through the speaker 1145, all under control of a Main Control Unit (MCU) 1103 which can be implemented as a Central Processing Unit (CPU) (not shown).

The MCU 1103 receives various signals including input signals from the keyboard 1147. The keyboard 1147 and/or the MCU 1103 in combination with other user input components (e.g., the microphone 1111) comprise a user interface circuitry for managing user input. The MCU 1103 runs a user interface software to facilitate user control of at least some functions of the mobile terminal 1101 to apply changes to a user interface. The MCU 1103 also delivers a display command and a switch command to the display 1107 and to the speech output switching controller, respectively. Further, the MCU 1103 exchanges information with the DSP 1105 and can access an optionally incorporated SIM card 1149 and a memory 1151. In addition, the MCU 1103 executes various control functions required of the terminal. The DSP 1105 may, depending upon the implementation, perform any of a variety of conventional digital processing functions on the voice signals. Additionally, DSP 1105 determines the background noise level of the local environment from the signals detected by microphone 1111 and sets the gain of microphone 1111 to a level selected to compensate for the natural tendency of the user of the mobile terminal 1101.

The CODEC 1113 includes the ADC 1123 and DAC 1143. The memory 1151 stores various data including call incoming tone data and is capable of storing other data including music data received via, e.g., the global Internet. The software module could reside in RAM memory, flash memory, registers, or any other form of writable storage medium known in the art. The memory device 1151 may be, but not limited to, a single memory, CD, DVD, ROM, RAM, EEPROM, optical storage, magnetic disk storage, flash memory storage, or any other non-volatile storage medium capable of storing digital data.

An optionally incorporated SIM card 1149 carries, for instance, important information, such as the cellular phone number, the carrier supplying service, subscription details, and security information. The SIM card 1149 serves primarily to identify the mobile terminal 1101 on a radio network. The card 1149 also contains a memory for storing a personal telephone number registry, text messages, and user specific mobile terminal settings.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

1. A method comprising:
receiving an input for specifying at least one change to one or more components of a first user interface;
determining to preserve respective execution states of one or more applications associated with the first user interface; and
determining to apply the at least one change to generate a second user interface for presenting the one or more applications based, at least in part, on the preserved respective execution states.

2. A method of claim 1, further comprising:
determining to initiate a transition between the first user interface and the second user interface based, at least in part, on predetermined criteria, user input, or a combination thereof.

3. A method of claim 1, further comprising:
determining to maintain the first user interface and the second user interface concurrently.

4. A method of claim 1, further comprising:
determining status information associated with the first user interface;
determining to restore at least a portion of the second user interface following application of the at least one change based, at least in part, on the status information.

5. A method of claim 4, wherein the status information includes one or more identifiers of the one or more applications, location and dimensional information of displays associated with the one or more applications, and status information of the windows.

6. A method of claim 1, further comprising:
determining to generate a notification to at least one of the one or more applications in response to the input for specifying the at least one change.

7. A method of claim 6, wherein the notification alerts the at least one application to initiate an operation to modify the at least one application based on the at least one change.

8. A method of claim 1, further comprising:
determining whether there is an update for one or more components,
wherein the at least one change is based, at least in part, on the update.

9. A method of claim 1, wherein the one or more components specify, at least in part, one or more characteristics for opening, closing, minimizing, maximizing, moving, resizing, navigating, or a combination thereof one or more outputs of the one or more applications.

10. An apparatus comprising:
at least one processor; and
at least one memory including computer program code for one or more programs,
the at least one memory and the computer program code configured to, with the at least one processor, cause the apparatus to perform at least the following,
receive an input for specifying at least one change to one or more components of a first user interface;
determine to preserve respective execution states of one or more applications associated with the first user interface; and
determine to apply the at least one change to generate a second user interface for presenting the one or more applications based, at least in part, on the preserved respective execution states.

11. An apparatus of claim 10, wherein the apparatus is further caused to:
determine to initiate a transition between the first user interface and the second user interface based, at least in part, on predetermined criteria, user input, or a combination thereof.

12. An apparatus of claim 10, wherein the apparatus is further caused to:
determine to maintain the first user interface and the second user interface concurrently.

13. An apparatus of claim 10, wherein the apparatus is further caused to:
determine status information associated with the first user interface;
determine to restore at least a portion of the second user interface following application of the at least one change based, at least in part, on the status information.

14. An apparatus of claim 13, wherein the status information includes one or more identifiers of the one or more applications, location and dimensional information of displays associated with the one or more applications, and status information of the windows.

15. An apparatus of claim 10, wherein the apparatus is further caused to:
determine to generate a notification to at least one of the one or more applications in response to the input for specifying the at least one change.

16. An apparatus of claim 15, wherein the notification alerts the at least one application to initiate an operation to modify the at least one application based on the at least one change.

17. An apparatus of claim 10, wherein the apparatus is further caused to:
determine whether there is an update for one or more components,
wherein the at least one change is based, at least in part, on the update.

18. An apparatus of claim 10, wherein the one or more components specify, at least in part, one or more characteristics for opening, closing, minimizing, maximizing, moving, resizing, navigating, or a combination thereof one or more outputs of the one or more applications.

19. A computer-readable storage medium carrying one or more sequences of one or more instructions which, when executed by one or more processors, cause an apparatus to at least perform the following steps:
receiving an input for specifying at least one change to one or more components of a first user interface;
determining to preserve respective execution states of one or more applications associated with the user interface; and
determining to apply the at least one change to generate a second user interface for presenting the one or more applications based, at least in part, on the preserved respective execution states.

20. A computer-readable storage medium of claim 19, wherein the apparatus is caused to further perform:
determining status information associated with the first user interface;
determining to restore at least a portion of the second user interface following application of the at least one change based, at least in part, on the status information.

21.-45. (canceled)
